(19) United States
(12) Patent Application Publication
(10) Pub. No.: US 2013/0336640 A1
(43) Pub. Date: Dec. 19, 2013

(54) SYSTEM AND METHOD FOR DISTRIBUTING COMPUTER GENERATED 3D VISUAL EFFECTS OVER A COMMUNICATIONS NETWORK

(71) Applicants: Alicia E. Nevarez, New York, NY (US); Mitchell P. Bunnel, New York, NY (US)

(72) Inventors: Alicia E. Nevarez, New York, NY (US); Mitchell P. Bunnel, New York, NY (US)

(73) Assignee: EFEXIO, INC., New York, NY (US)

(21) Appl. No.: 13/524,041

(22) Filed: Jun. 15, 2012

(51) Int. Cl. G11B 27/02

(52) U.S. Cl. 386/280; 386/E05.028

(57) ABSTRACT

A system and method for distributing computer generated 3D visual effects over a communications network. The method includes receiving a computer generated 3D visual effect in a scene file format; and providing a user interface that permits simultaneous rendering and compositing of the computer generated 3D visual effect on a frame-by-frame basis with a digital video, wherein the user interface is configured to allow adjusting of a control that alters rendering of the computer generated 3D visual effect. The system includes: a database that stores a computer generated 3D visual effect in a scene file format; and a user interface that provides access to the database and is configured to allow the computer generated 3D visual effect to be rendered and composited on a frame-by-frame basis with a digital video, wherein the user interface permits manipulation of a control that alters rendering of the computer generated 3D visual effect.

### FIELD OF THE INVENTION

This invention relates to the field of distribution of computer generated 3D visual effects (“CG 3D visual effects”) that can be customized and added to digital videos.

### BACKGROUND

The addition of CG 3D visual effects to digital video today is almost entirely done by professionals involved in the production of motion pictures, television shows, videogames or video advertisements. Professional visual effects artists are asked to create CG 3D visual effects for specific video footage that has either already been shot or already envisioned. These artists create CG 3D visual effects using professional 3D design and animation software, such as Autodesk® Maya® and 3ds Max®. CG 3D visual effects created using this software are typically stored in a file referred to as a scene file. Scene files must be rendered into two-dimensional images before being displayed. The artist exports the rendered CG 3D visual effect in digital video format or as a series of two-dimensional images. A video production compositing professional skilled in the use of professional compositing software then composites the CG 3D visual effect in digital video format or as a series of two-dimensional images with the video. Once the CG 3D visual effect is exported in digital video format or as a series of two-dimensional images, it cannot be changed. In order to add the CG 3D visual effect to a different video in a realistic manner, the CG 3D visual effect would have to be modified with the original or compatible professional 3D design and animation software. This can only be done by someone with the skills to use the professional 3D design and animation software and it can take significant time and expense.

Aside from the process described above where the artist is either hired as a contractor or an employee to create CG 3D visual effects, an artist can distribute CG 3D visual effects he owns, but only in their native format or pre-rendered as a series of two-dimensional images or as digital video. Distributing CG 3D visual effects in native format means that only those with the expertise to use professional compositing and compatible professional 3D design and animation software can add CG 3D visual effects to digital videos and only those with the expertise to use compatible professional 3D design and animation software can modify CG 3D visual effects to be able to realistically add them to digital video. Therefore, artists today cannot easily distribute CG 3D visual effects they own directly to consumers who do not have the skills to use such professional software, including consumers or professionals producing videos for commercial purposes who do not have access to a visual effects artist resource.

Distributing CG 3D visual effects pre-rendered as a series of two-dimensional images or as digital video means that the CG 3D visual effect cannot be changed in any way and as such consumers cannot realistically add them to any video. In this case, the video would have to be made with the pre-rendered CG 3D visual effect in mind. Being able to distribute CG 3D visual effects only in their native format or pre-rendered limits the size of the market to which artists can distribute CG 3D visual effects they own. To allow artists to fully monetize their CG 3D visual effects, there is a need for a system and method that allows anyone, even those without specific expertise, to modify CG 3D visual effects, and composite the CG 3D visual effects with any digital video in a realistic manner without the need for compatible professional 3D design and animation software and professional compositing software. Such a system and method would allow artists to fully monetize their CG 3D visual effects by making it possible for the artist to distribute the CG 3D visual effect in a format that is usable by anyone. In addition to the limited market for CG 3D visual effects distributed in their native format, when an artist distributes a CG 3D visual effect in this way, it can be completely modified by anyone who can use compatible professional 3D design and animation software. Therefore, the artist loses control over how his work is modified. To protect the artist's creations but still enable modifications that allow for the realistic addition of CG 3D visual effects to digital video, there is a need for a system that limits the way in which CG 3D visual effects can be modified.

### SUMMARY OF THE INVENTION

The present invention provides a system and method for distributing CG 3D visual effects over a communications network. The present invention is aimed at resolving the problem of artists not being able to sell CG 3D visual effects they own to others who do not have the skill to use professional 3D design and animation software and professional compositing software. The present invention allows consumers to make modifications that enable the realistic addition of CG 3D visual effects to digital videos by providing a system and method that delivers CG 3D visual effects in a scene file format that can be modified, but only in a limited manner. By allowing only limited modifications to be made and thereby eliminating the complexity of allowing unlimited modifications, the system and method allows anyone to modify a CG 3D visual effect so that it can be realistically added to a variety of digital videos. By limiting the manner in which a CG 3D visual effect can be modified, the system and method also protects an artist's work.

In accordance with one aspect of the invention, a method for distributing computer generated 3D visual effects over a communications network is provided. The method includes receiving a computer generated 3D visual effect in a scene file format and providing a user interface that permits simultaneous rendering and compositing of the computer generated 3D visual effect on a frame-by frame basis with a digital video, wherein the user interface is configured to allow adjusting of a control that alters rendering of the computer generated 3D visual effect. By simultaneously rendering and compositing the computer generated 3D visual effect with the digital video, a consumer is able to receive instantaneous feedback when adding the computer generated 3D visual effect to the digital video.

In accordance with another aspect of the invention, a system for distributing computer generated 3D visual effects over a communications network is provided. The system includes a database that stores a computer generated 3D visual effect in a scene file format, and a user interface that provides access to the database and is configured to allow the computer generated 3D visual effect in the scene file format to be rendered and composited on a frame-by-frame basis with digital videos, wherein the user interface is configured to permit manipulation of a control that alters rendering of the computer generated 3D visual effect. Similar to the method described above, the system provides a consumer with instantaneous feedback when adding the computer generated 3D visual effect to the digital video. This system allows consumers who are not skilled with complex design and animation software to easily add computer generated 3D visual effects to digital videos.

### BRIEF DESCRIPTION OF THE DRAWINGS

In order to appreciate the manner in which the advantages and objects of the invention are obtained, a more particular description of the invention will be rendered by reference to specific embodiments thereof which are illustrated in the appended drawings. Understanding that these drawings only depict preferred embodiments of the present invention and are not therefore to be considered limiting in scope, the invention will be described and explained with additional specificity and detail through the use of the accompanying drawings in which:

FIG. 1 is a block diagram of a system for distributing CG 3D visual effects in a scene file format over a communications network in accordance with an exemplary embodiment.

FIG. 2 is an image of a converting add-on for converting CG 3D visual effects into a scene file format in accordance with an exemplary embodiment.

FIG. 3 is an image of a user interface for integrating a CG 3D visual effect in a scene file format into a digital video in accordance with an exemplary embodiment.

FIG. 4 is an image of a user interface for integrating a CG 3D visual effect in a scene file format into a digital videos in accordance with an exemplary embodiment.

FIG. 5 illustrates the process for simultaneously rendering and compositing a CG 3D visual effect in a scene file format with a digital video.

FIG. 6 is a flow chart for the method for matching the movement of the virtual camera with the movement of the real camera used to shoot the digital video.

FIG. 7 is a flow chart for the method used to simulate interaction between a feature in a digital video and an object in the CG 3D visual effect in a scene file format.

FIG. 8 is a flow chart showing a method for adjusting 3D guides to reflect changes in the virtual camera angle.

FIG. 9 is an image of 3D guides showing the movement of a CG 3D visual effect in the scene file format over time.

### DETAILED DESCRIPTION

It will be readily understood that the components of the present invention, as generally described and illustrated in the figures herein, could be arranged and designed in a wide variety of configurations. Thus, the following detailed description of the embodiments of the system and method is not intended to limit the scope of the invention, but is merely representative of the presently preferred embodiments.

The term CG 3D visual effects refers to at least one computer generated 3D model, which may be animated, that uses a collection of geometric data (e.g., Cartesian), a description of object surfaces, and lights to represent a scene in 3D space. Examples of CG 3D visual effects include, but are not limited to, a combination of computer generated 3D models, computer generated 3D models with animation and/or procedural effects such as smoke, dust and fire, as well as, computer generated 3D models that are physically simulated.

Animation refers to the temporal description of a CG 3D visual effect. The temporal description of an object defines how it moves, deforms and interacts over time.

Digital video refers to a series of one or more orthogonal bitmap digital images displayed in rapid succession at a constant rate. In the context of video, these images are called frames.

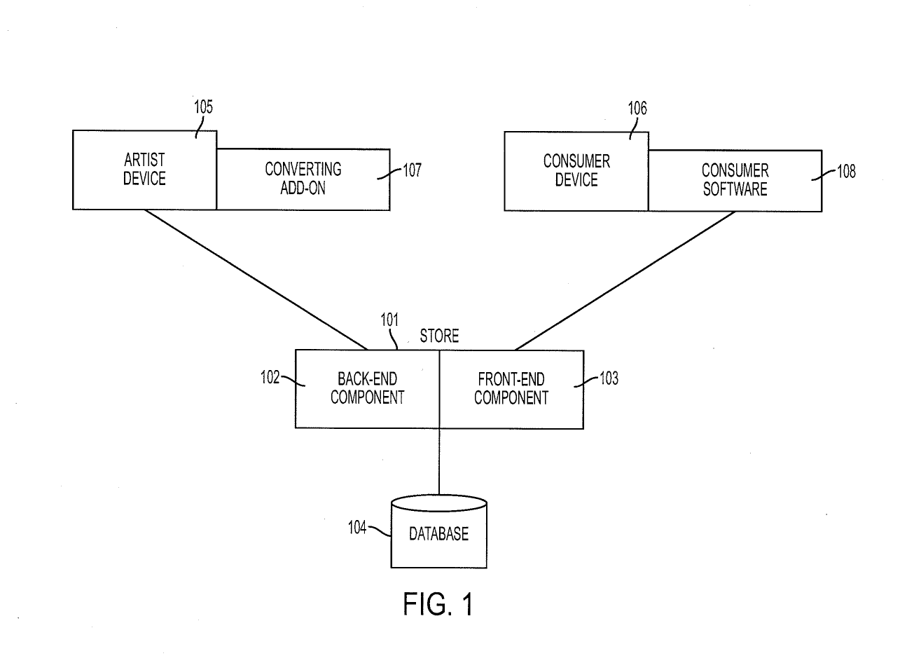

FIG. 1 is a block diagram for a system for distributing CG 3D visual effects in a scene file format over a communications network in accordance with the exemplary embodiment. In the exemplary embodiment, the system is comprised of a store 101, a database 104, at least one artist device 105, at least one consumer device 106, a converting add-on 107, and consumer software 108. Preferably, the store 101 is resident on a remote computer acting as a server. The store 101 consists of a front-end component 103 and a back-end component 102. The artist device 105 or the consumer device 106 connects to the store 101 via a computer network. The consumer and artist devices 105, 106 include, but are not limited to, personal computers, smart phones, tablets and the like. The store 101 is configured to provide the artist and consumer devices 105, 106 with access to the back-end component 102 or the front-end component 103. The system stores CG 3D visual effects in a scene file format in the database 104. The front-end component 103, the consumer software 108, the back-end component 102, and the converting add-on 107 will be explained in greater detail below.

While those skilled in the art will appreciate that the invention may be practiced in a networked computing environment with many types of computer system configurations, FIG. 1 represents an embodiment of the present invention in a networked environment that includes users connected to a server via a network. While FIG. 1 illustrates an embodiment that includes two users connected to the network, alternative embodiments include one user connected to a network or many users connected to a network. Additionally, embodiments in accordance with the present invention also include a multitude of users throughout the world connected to a network, where the network is a wide area network, such as the Internet.

Preferably, an artist can download the converting add-on 107 using the artist device 105. Typically, the converting add-on is used by artists, but anyone who wants to create and upload a CG 3D visual effect in the scene file format may also use the converting add-on. The converting add-on 107 is preferably configured as a plug-in or add-on for 3D design and animation software suites which operate on the artist's device 105. The artist creates a CG 3D visual effect using known professional 3D design and animation software suites such as Autodesk® Maya® or 3ds Max®. The converting add-on 107 converts the CG 3D visual effect into a scene file format that allows only limited modifications to be made to the CG 3D visual effect. In the exemplary embodiment, the converting add-on 107 encrypts the CG 3D visual effect in the scene file format with a public key.

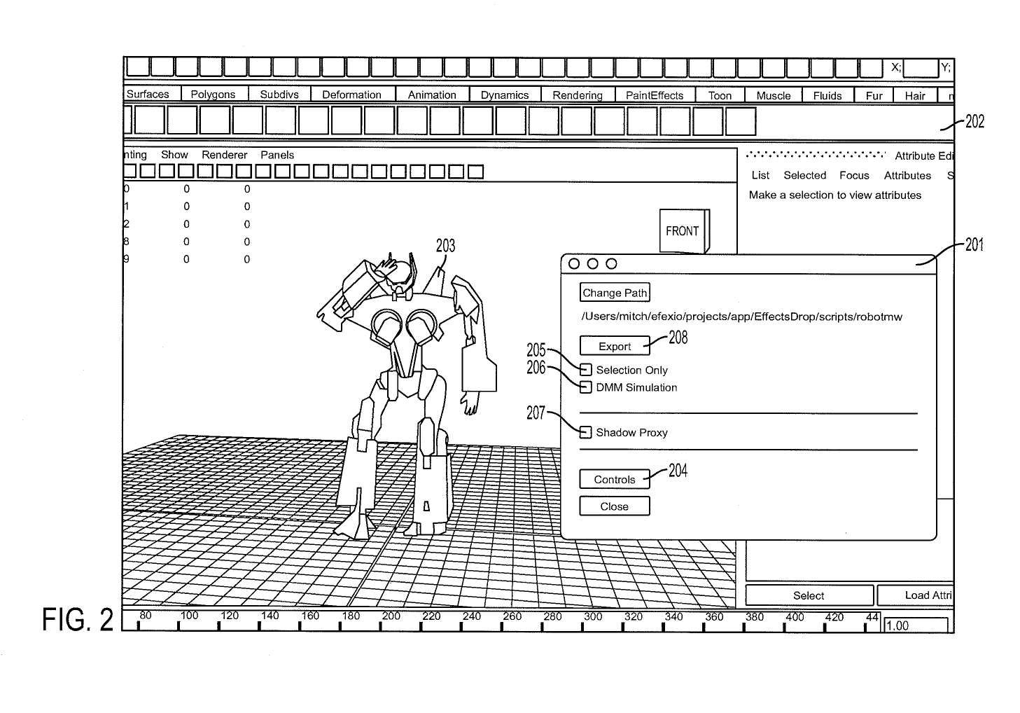

FIG. 2 depicts a user interface 201 for the converting add-on 107. In the exemplary embodiment, the user interface 201 is viewed as a window in a professional 3D design and animation software suite 202. Button 204 allows the artist to define custom adjustments as well as controls for the custom adjustments for the CG 3D visual effect in the scene file format 203. Exemplary custom adjustments and controls will be described in more detail below. Selection boxes 205, 206 and 207 allow the artist to select certain features to be included in the scene file format. For example, an artist may create a CG 3D visual effect that includes a plurality of objects. Check box 205 allows artists to export only those objects of the CG 3D visual effect that he has selected. Once the artist has finished designing the CG 3D visual effect, and has chosen which objects to include, button 208 completes the process by converting the CG 3D visual effect into the scene file format, allowing it to be saved and uploaded to the back-end component 102 of the store 101 at a later time. Alternatively, the converting add-on 107 can be configured to allow the artist to create and upload the scene file immediately to the back-end component 102 of the store 101.

The created scene file format is composed of geometric data, texture maps, lights, surface material descriptions and, if the CG 3D visual effect in the scene file format includes animation, a description of the animation as spline data that captures all changes in transforms and mesh deformations by encoding all changes of all the vertices of the geometry. The scene file format does not include the construction graph of the geometry of the CG 3D visual effect, and as such, no major changes to the geometry can be carried out.

The scene file format of the exemplary embodiment differs from other known scene file formats in a number of ways. In prior art systems, scene files include construction graphs for geometry and references to texture maps (which are in separate image files) as well as information that allows for animation of the CG 3D visual effect. A construction graph is a history of how a CG 3D visual effect was built. If an artist has a construction graph for a particular CG 3D visual effect, he can modify its geometry however he wants. Moreover, if the artist has information that allows for the animation of the CG 3D visual effect, in addition to the construction graph, he can make substantial modifications to any animations included in the CG 3D visual effect.

The scene file format of the exemplary embodiment does not include construction graphs of the geometry of the CG 3D visual effect and, as such, the geometry can only be modified in a limited way. Nor does the scene file format of the exemplary embodiment include data to animate the geometry, and as such, animations cannot be modified. Rather, the scene file format of the exemplary embodiment includes a description of the animation as spline data that captures all changes in transforms and mesh deformations by encoding all changes of all the vertices of the geometry. Spline data represents the movement of a vertex in three dimensional space as a mathematical equation. In the preferred embodiment, all vertices that move during animation are mapped. The scene file format then uses cubic equations to represent the movement of those vertices. Another difference from prior art systems is that the scene file format of the exemplary embodiment includes texture maps in the same file as opposed to references to separate image files.

An important benefit of the scene file format of the preferred embodiment is that it requires much less dynamic memory to render than a comparably and reasonably complex CG 3D visual effect in a typical scene file format because the scene file format of the exemplary embodiment contains less data about the CG 3D visual effect. Consequently, CG 3D visual effects in the scene file format of the exemplary embodiment can be rendered on a number of devices that do not have the capability to render the more data intensive scene files, like mobile devices.

The scene file format may also include custom controls, defined by the artist, that allow for custom adjustments that are specific to a particular CG 3D visual effect. These custom controls can be any type of control that adjusts, in any way, the visual appearance of the CG 3D visual effect in the scene file format. Examples of custom adjustments include, but are not limited to, the ability to change elements in the CG 3D visual effect in the scene file format such as the color of objects; the amount of flames, rain, snow or lighting; the time of day; and the strength of wind. These adjustments can be implemented using, for example, sliders, radio buttons or check boxes.

Once the artist has created the CG 3D visual effect and converted it to the scene file format, he can then upload it to the back-end component 102 store 101. In order to upload the CG 3D visual effect in the scene file format to the store, the artist connects to the back-end component 102 of the store with the artist device 105. The back-end component 102 of the store 101 is configured to receive encrypted CG 3D visual effects in the scene file format. The back-end component 102 of the store 101 then decrypts the encrypted CG 3D visual effect in the scene file format before storing it in the database 104.

In one embodiment, the back-end component 102 of the store 101 is configured to provide an interface that allows artists to perform administrative functions. These administrative functions include creating an account, filling out an artist profile, selecting a category that identifies the CG 3D visual effect in the scene file format, and setting the price for which CG 3D visual effects in the scene file format will be sold through the front-end component 103. In order to set the price for a CG 3D visual effect in the scene file format, the artist may select a price from a pricing schedule provided by the back-end component 102 of the store 101.

In the exemplary embodiment, a consumer is provided with the consumer software 108. The consumer software 108 is preferably configured to operate on the consumer device 106. One function of the consumer software 108 is to provide a user interface for interacting with the front-end component 103 so as to allow the consumer to browse CG 3D visual effects in the scene file format available through the store 101. To accomplish this, the consumer device 106 preferably connects to the front-end component 103 of the store 101 over a network, and makes queries to the database 104. When the consumer accesses the front-end component 103 of the store 101 through the consumer software 108, the consumer can browse, select and preview CG 3D visual effects in the scene file format stored in the database 104. Consumers can also purchase CG 3D visual effects in the scene file format from the store 101. Typical forms of payment, such as credit cards, can be used to purchase CG 3D visual effects in the scene file format.

The consumer software 108 can be embodied as an application, an application for mobile devices, an applet, web software, or the like. While the consumer software 108 is preferably configured to operate on the consumer device 106, the consumer software 108 may also be configured to operate and reside on one or more servers. For example, the consumer software 108 may operate on the server running the store 101. Alternatively, the consumer software 108 may operate on a plurality of servers unrelated to the store 101. When the consumer software 108 operates remotely, it provides an interface to the consumer device 106, but performs all functions on one or more remote servers.

The consumer software 108 is preferably configured to allow consumers to download CG 3D visual effects in the scene file format they have purchased to the consumer device 106. In one embodiment, the consumer registers the consumer device with the front-end component 103 of the store 101. The front-end component 103 of the store 101 will first authenticate the consumer device 106 before transmitting the CG 3D visual effect in the scene file format to that device. When transmitting the CG 3D visual effect in the scene file format, the front-end component 103 of the store 101 encrypts the file for a specific consumer. Encryption and authentication ensures that CG 3D visual effects in the scene file format cannot be shared among different consumers, nor downloaded on a device that has not been registered. Authentication also ensures that only CG 3D visual effects in the scene file format acquired via the front-end component 103 can be downloaded on a consumer device 106. Additionally, encryption ensures that the CG 3D visual effect in the scene file format can only be modified as allowed by the consumer software 108. As one of skill in the art would readily understand, while the use of encryption is preferred, the system of the present invention can operate without using such encrypted files.

Additionally, the consumer software 108 is preferably configured to provide the consumer with a library to organize purchased CG 3D visual effects in the scene file format. The library allows 3D visual effects to be categorized and grouped for easy retrieval and use. In one embodiment, the consumer software 108 organizes CG 3D visual effects in the scene file format in the library according to category data which the artist selects using the back-end component 102 of the store 101 when uploading the CG 3D visual effect in the scene file format.

The front-end component 103 of the store 101 is also preferably configured to allow consumers to perform administrative functions, such as creating a user account and submitting ratings and reviews for CG 3D visual effects in the scene file format on the store 101.

In the exemplary embodiment, the consumer software 108 is configured to retrieve digital videos stored locally on the consumer device 106 or stored remotely over a network. The consumer software 108 is also configured to allow the consumer to capture digital videos from within the consumer software 108. Once the consumer software 108 has retrieved or captured the digital video, the consumer can then add CG 3D visual effects in the scene file format purchased from the front-end component 103 to that digital video.

To add CG 3D visual effects in the scene file format to a digital video, the consumer selects one or more CG 3D visual effects in the scene file format that were previously purchased from the front-end component 103 of the store 101. The consumer software 108 is preferably configured to simultaneously render and composite one or more CG 3D visual effects in the scene file format on a frame-by-frame basis with a digital video to produce a new digital video including the CG 3D visual effect in the scene file format. Simultaneously rendering and compositing the CG 3D visual effect in the scene file format with the consumer's digital video is important because it provides instant visual feedback to a consumer as he manipulates controls for blending the CG 3D visual effect in the scene file format into the consumer's digital video. The process of simultaneously compositing and rendering the CG 3D visual effect in the scene file format with the consumer's digital video will be described in more detail below.

Blending controls provided by the consumer software 108 are used to modify the CG 3D visual effect in the scene file format so that it can be realistically integrated with any digital video. In the exemplary embodiment, blending controls include changing the direction of light(s), color of directional light(s), color of ambient light, orientation, size, position, shadow color, sharpness and lightness, sharpness and color cast of the CG 3D visual effect in the scene file format, fog density and color, angle view and camera zoom. Blending controls may be provided for any adjustment that affects the ability to integrate the CG 3D visual effect in the scene file format realistically into frames of a digital video. Unlike the prior art, the consumer software 108 does not composite pre-rendered CG 3D visual effects in the scene file format with digital videos. Rather, the consumer software 108 simultaneously renders and composites the CG 3D visual effect in the scene file format on a frame-by-frame basis with a digital video. This allows the consumer to rotate the CG 3D visual effect in the scene file format in three dimensions; scale the CG 3D visual effect while maintaining the visual quality of the CG 3D visual effect in the scene file format; match the reflections and shadows on objects to those in the digital video; change the fog density; and change the perspective from which the CG 3D visual effect in the scene file format is viewed. All these adjustments would not be possible with a pre-rendered CG 3D visual effect.

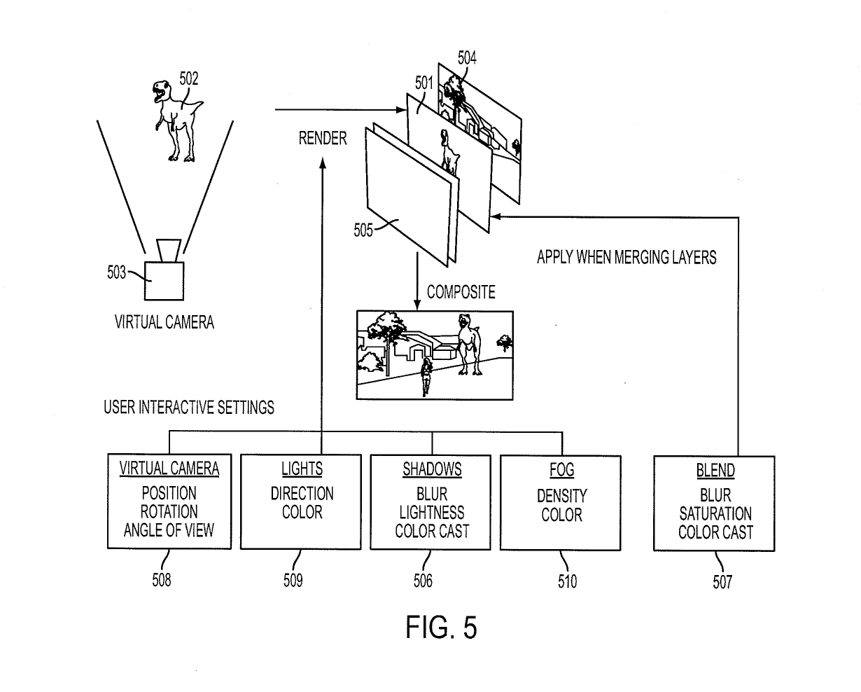

FIG. 5 is a visual representation of the simultaneous rendering and compositing process. In order to accomplish simultaneous compositing and rendering, the consumer software 108 sets a binary flag any time the consumer manipulates a blending control. In the preferred embodiment, the consumer software 108 checks this flag thirty times every second. If the flag is set, the display is refreshed for the consumer and the flag is cleared.

To refresh the display, an off-screen buffer 501 is used to render the CG 3D visual effect in the scene file format 502 from the point of view of the virtual camera 503. This buffer, hereinafter referred to as the current rendering layer, is cleared to transparent before the CG 3D visual effect in the scene file format 502 is rendered. Next, the current background digital video frame is drawn to a second off-screen buffer 504. The current rendering layer 501 is then drawn over the second buffer 504 with transparent or partially transparent pixels allowing the background 504 to show through in parts. Finally, any foreground digital video layers 505 are drawn over the second buffer 504. These will also have transparent regions or have colors that are chroma-keyed so that pixels with the key color become transparent and allow lower layer pixels to show through.

Conventional real-time rendering techniques are used to render the three dimensional effect to create the current rendering layer 501. A graphics processor (GPU) is programmed to draw all of the triangles that make up all of the objects in the CG 3D visual effect in the scene file format 502 once for each light source to generate a per light source shadow map. The GPU will also do this for the view described by the virtual camera 503. The shadow maps are then used to generate shadows using a traditional Percentage Closer Shadows (“PCS”) technique. For shadows that appear on objects that are only in the digital video, shadow proxies are used. These proxies are 3D objects that have no color of their own but are given a color where shadows are cast. The most common example of a shadow proxy is a floor or ground. A blending control for shadow blur 506 adjusts the sample size for the PCS technique. A blending control for shadow color cast 506 adjusts the color used with the transparency set by the a separate control for shadow lightness 506. Other blending controls that the consumer can manipulate affect the current rendering layer as well. For example, the consumer can select the position of the virtual camera 508, the color of the lights 509, or even the color of fog 510.

When drawing the current render layer 501 over the background digital video frame 504, the current render layer 501 is first blurred using a two-pass (one pass to blur in the horizontal direction, and one pass for the vertical direction) finite impulse response (“FIR”) filter according to a blending blur parameter 507 set by the consumer. The saturation of each pixel can be adjusted by the consumer using a blending control for blend saturation 507. The blend saturation control 507 operates by linearly interpolating between the RGB color and the monochrome of the RGB color with an interpolation value between 0 and 2—0 being monochrome, 1 being no change in saturation, and 2 being very bright colors. Finally, each pixel is modulated by a parameter set by the consumer using a blending control for color cast 507.

When simultaneously rendering and compositing a CG 3D visual effect in the scene file format with a digital video, the consumer software 108 provides the consumer with a “what you see is what you get” (“WYSIWYG”) interface. In the WYSIWYG interface, the consumer can view a CG 3D visual effect in the scene file format within a frame of the consumer's own digital video. This allows easy placement, rotation and sizing of the CG 3D visual effect in the scene file format.

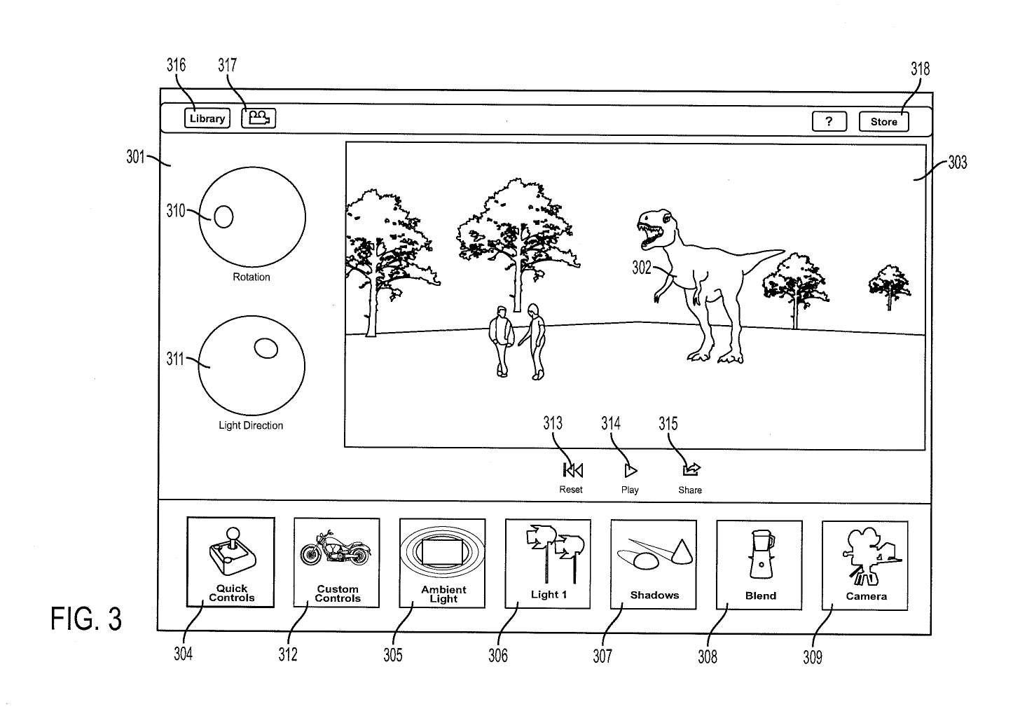

FIG. 3 depicts the WYSIWYG interface 301 provided by the consumer software 108 for integrating CG 3D visual effects in the scene file format into digital videos in accordance with the exemplary embodiment. The CG 3D visual effect in the scene file format 302 is displayed in a frame 303 of the consumer's digital video. Buttons 304, 305, 306, 307, 308 and 309 are used to bring up blending controls for adjusting, among other things, the direction of light(s), color of directional light(s), color of ambient light, orientation, size, position, shadow color, sharpness and lightness, sharpness and color cast of the CG 3D visual effect in the scene file format, fog density and color, angle view and camera zoom. In FIG. 3, the “Quick Controls” button 304 is selected. This brings up blending controls 310 and 311. Virtual trackball 310 is used to rotate the CG 3D visual effect in the scene file format 302 in three dimensions and virtual trackball 311 is used to adjust the direction of the light source on the CG 3D visual effect 302. These controls allow the consumer to adjust the direction of the light source to match the direction of the light source in the consumer's digital video; to adjust the angle of view of the CG 3D visual effect in the scene file format so that it matches the angle from which the digital video was shot and select the side from which the consumer wants to view the CG 3D visual effect in the scene file format; and to select the desired position of the CG 3D visual effect in the scene file format within the digital video. A click-and-drag or touch-and-drag motion anywhere in the frame 303 allows the consumer to change the position of the CG 3D visual effect in the scene file format. A pinch gesture in the frame 303 allows the consumer to change the size of the CG 3D visual effect in the scene file format. Button 314 plays the CG 3D visual effect in the scene file format animation and button 313 resets the animation to the beginning. Button 315 directs the consumer software 108 to export the consumer's digital video containing the CG 3D visual effect in the scene file format to a consumer's digital media library, or export it to social networking platforms and online digital media platforms via the network. Button 312, labeled “Custom Controls,” brings up controls for custom adjustments included by the artist in the CG 3D visual effect in the scene file format. Button 316 accesses a consumer's library of purchased CG 3D visual effects in the scene file format. Button 317 opens a digital video stored on the consumer device 106 or stored remotely over a network. Button 318 accesses the front-end component 103 of the store 101.

The consumer software 108 also preferably allows the consumer to manipulate any custom adjustments included in the CG 3D visual effect in the scene file format. Custom adjustments and the controls for these adjustments are defined by the artist, as described above, when converting a CG 3D visual effect into the scene file format and include any type of control that adjusts, in any way, the visual appearance of the CG 3D visual effect in the scene file format. Examples of custom adjustments include, but are not limited to, the ability to change elements in the CG 3D visual effect in the scene file format such as the color of objects, the amount of flames, rain, snow or lighting; the time of day; and the strength of wind. These adjustments can be made using controls defined by the artist. Examples of such controls include, but are not limited to, sliders, radio buttons or check boxes.

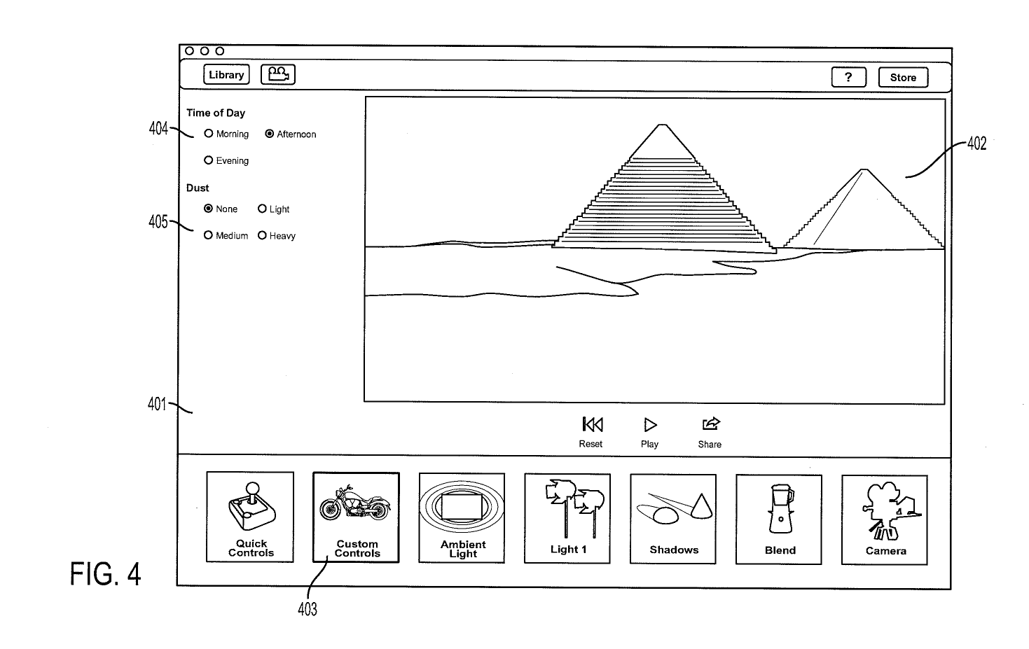

FIG. 4 depicts the WYSIWYG interface 401 provided by the consumer software 108 for adjusting custom controls defined by the artist. These controls are brought up by selecting the “Custom Controls” button 403. In FIG. 4, the CG 3D visual effect in the scene file format 402 is a desert scene including pyramids. Control 404 allows the consumer to select the time of day in the desert, and therefore the lighting of the scene, while control 405 allows the consumer to select the amount of dust included in the desert scene.

In another aspect, the consumer software 108 is configured to perform other types of adjustments. One such type of adjustment is to match the movement of the virtual camera with the real camera used to shoot a digital video. The virtual camera refers to the perspective from which the CG 3D visual effect in the scene file format is viewed. When the virtual camera matches the real camera used to shoot the digital video, the CG 3D visual effect in the scene file format appears as though it was part of the original digital video. This allows the consumer to add CG 3D visual effects in the scene file format to the digital video even if the real camera used to shoot the digital video moved during shooting.

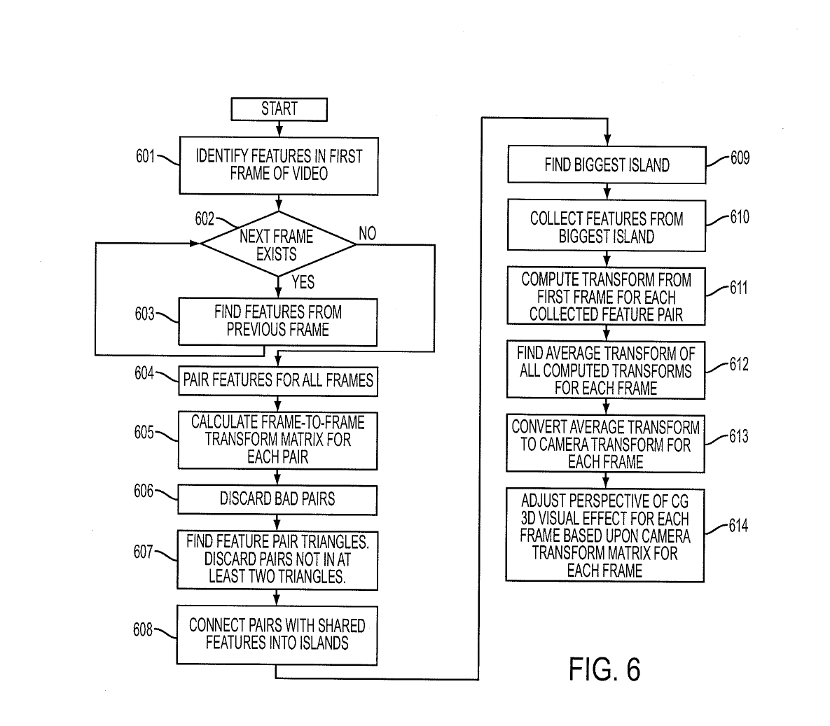

FIG. 6 is a flow chart depicting the method for matching the movement of the virtual camera to the movement of the real camera. In step 601, the consumer software 108 identifies features to be tracked in the first frame of the consumer's video, preferably by using the cvGoodFeaturesToTrack( ) routine in the publicly available library OpenCV. The consumer software 108 then determines whether another frame of the consumer's digital video exists, or if the video is finished in step 602. If a subsequent frame exists, the features identified from the first frame are identified for that subsequent frame in step 603, preferably by calling the OpenCV function cvMatchTemplate( ).

Once the features identified in the first frame of the consumer's digital video have been identified for every frame of the consumer's digital video, the consumer software 108 moves on to step 604. In step 604, the consumer software 108 creates pairs of features for all frames of the consumer's digital video. For each pair of features identified in step 604, the consumer software will calculate a frame-to-frame transform matrix in step 605. Step 606 discards pairs of features that require a transform with more than three degrees of freedom.

Next, in step 607, the consumer software 108 identifies sets of three features connected pair-wise in three pairs. These sets of features are deemed triangles. All feature pairs that are not in at least two triangles are thrown out. Feature pairs that share a common feature are then gathered together in what are referred to as islands in step 608. In step 609, the consumer software 108 identifies the island having the most common features. And in step 610, the consumer software 108 discards all feature pairs not on the island having the most common features.

In step 611 the consumer software 108 next calculates the transform matrix from the first frame to each subsequent frame for each feature pair not discarded in step 610. Transforms that require more than three degrees of freedom are thrown out, as are transforms with substantial rotation or translation. The amount of acceptable rotation or translation is predetermined by the consumer software 108. Once all of the transforms are calculated in step 611, an average of all of the transforms is computed for each frame in step 612. Each transform may consist of horizontal translation, vertical translation, and rotation. In step 613, the average transform for each frame is converted to a camera transformation matrix where horizontal translation is converted to camera yaw, vertical translation is converted to camera pitch, and rotation is converted to camera roll. Finally, the camera transform matrix created in step 613 is used to adjust the perspective from which the CG 3D visual effect in the scene file format is viewed in each frame of the consumer's digital video in step 614. The perspective is adjusted by multiplying the current virtual camera matrix by the camera transform matrix created in step 613.

The consumer software 108 is also preferably configured to interact with a physical simulator. Through interaction with the physical simulator, the consumer software 108 can create movement, deformation and even fracture of objects in a CG 3D visual effect so that the objects appear to interact with elements of a digital video. An example would be the effect of a board breaking when it appears to be “karate chopped” by a person in a video. The board does not exist in the video, but is part of the CG 3D visual effect in the scene file format.

Objects in the CG 3D visual effect in the scene file format that appear to interact with features of a digital video can be authored to allow for physical simulation. Digital Molecular Matter® (“DMM”), which is a technology available from Pixelux Entertainment, S.A. includes software to author 3D objects that have physical characteristics. DMM also includes a Finite Element Method (“FEM”) based simulator, which can simulate the actions of any number of objects in a simulation scene. Each simulated object is represented by a tetrahedral mesh. Forces can be applied, and mesh elements moved to desired positions on a frame-by-frame basis. The results of the simulation are preferably read on a frame-by-frame basis.

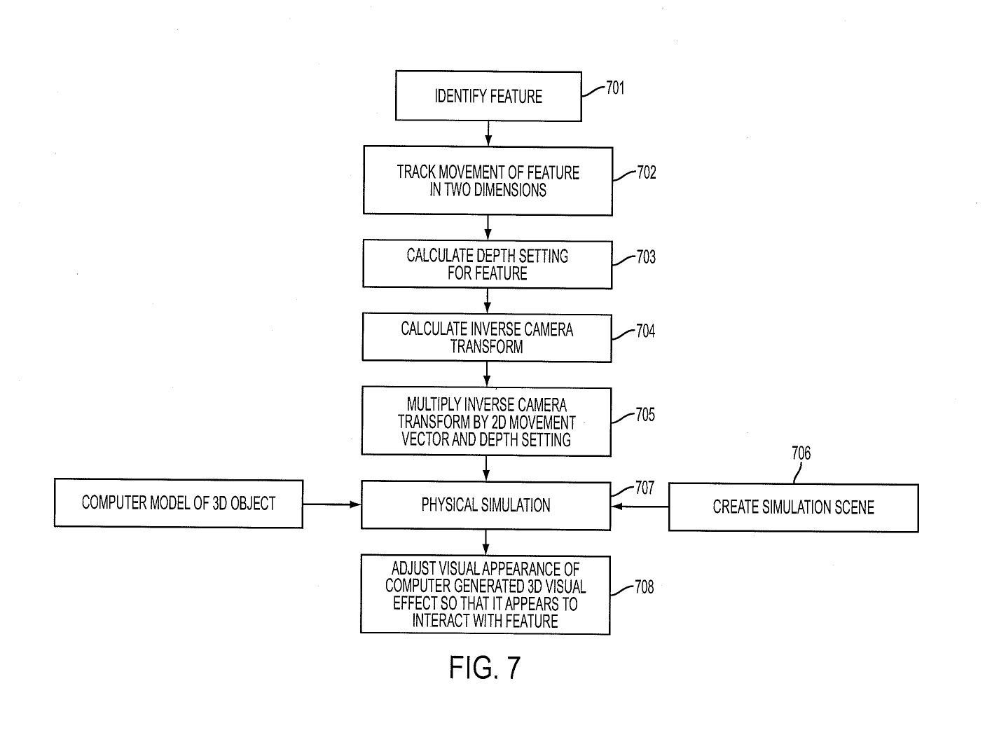

FIG. 7 is a flow chart depicting the method used to simulate interaction between a feature in a digital video and an object in the CG 3D visual effect in the scene file format. First, a feature that will interact with the CG 3D visual effect in the scene file format in the consumer's digital video is identified in step 701. In the preferred embodiment, the consumer can identify which feature in the digital video will interact with an object in the CG 3D visual effect in the scene file format. Once the feature has been identified, the OpenCV function cvMatchTemplate( )is used to track the position of the feature for each successive frame of the consumer's digital video in step 702. Step 702 tracks the movement of the element in two dimensions. In order to simulate interaction with three dimensional objects, a depth measurement for the feature is also needed. In step 703, the consumer software 108 determines the depth measurement of the feature. The depth measurement represents the distance into the screen. In the preferred embodiment, the consumer can set the depth measurement.

Next, in step 704 the consumer software 108 calculates an inverse virtual camera transform matrix, just like in step 613 above. In step 705, the consumer software 108 multiplies the inverse virtual camera transform from step 704 by a vector consisting of the two dimensional coordinates from step 702 and the depth measurement from step 703. The feature can be rendered as a shape, preferably a tetrahedron, which is repositioned on a frame-by-frame basis according to the resulting vector from step 704. In the preferred embodiment, the consumer can then view the movement of the shape on a frame-by-frame basis and adjust a depth control for the shape by comparing the position of the shape to the position of objects in the CG 3D visual effect in the scene file format. As the consumer adjusts the depth, the position of the shape is recalculated and the display is refreshed to show the consumer the new position.

In step 706, a simulation scene is created using the FEM simulation software. All of the objects in the CG 3D visual effect in the scene file format that have been authored for simulation are placed in the simulation scene. Then, in step 707, the consumer software 108 inputs the vector created in step 705, the simulation scene created in step 706, and a model of the object that has been authored for interaction to a physical simulator on a frame-by-frame basis. The output from the simulator is then used to adjust the visual appearance of the CG 3D visual effect in the scene file format on a frame-by-frame basis so that it appears to interact with the feature identified in step 701.

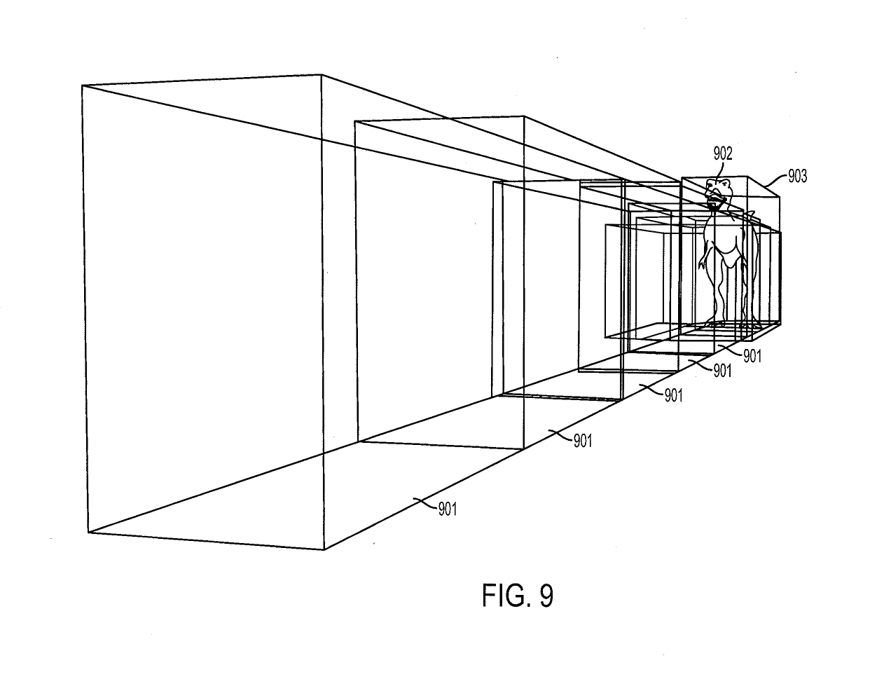

With reference to FIG. 9, the consumer software 108 is also preferably configured to provide 3D guides when rendering and compositing the CG 3D visual effect in the scene file format on a frame-by-frame basis with a digital video. Some CG 3D visual effects in the scene file format have animated objects that move from one position to another position over the length of the animation. This movement may make it difficult for the consumer to realistically position and orient the CG 3D visual effect in the scene file format in a frame of the digital video. 3D guides function to aid the consumer to position the animated CG 3D visual effect in the scene file format into the digital video and set the angle of view for the virtual camera within a frame of the digital video.

The consumer software 108 is preferably configured to generate the 3D guides for a CG 3D visual effect in the scene file format without input from the artist. In order to generate 3D guides, the consumer software 108 calculates 3D axis-aligned bounding boxes 901 for all objects in the CG 3D visual effect in the scene file format 902 that cast shadows at predetermined intervals in the animation. These bounding boxes 901 represent the position, size and orientation of the CG 3D visual effect in the scene file format 902 at each of the predetermined intervals. In the preferred embodiment, the consumer software 108 calculates 3D axis-aligned bounding boxes 901 in one-second time intervals. Consequently, the consumer can see the position, size and orientation of the CG 3D visual effect in the scene file format 902 as represented by the 3D axis-aligned bounding boxes 901 for each second of the animation.

The axis-aligned bounding boxes 901 are drawn to the current render layer using the same virtual camera used to draw the CG 3D visual effect in the scene file format during simultaneous rendering and compositing. Each axis-aligned bounding box 901 is preferably represented as a single color wireframe, and a bounding box for the current animation frame 903 is preferably displayed as a different color than the other bounding boxes 901. The consumer software 108 calculates 3D axis-aligned bounding boxes 901, 903 for a particular CG 3D visual effect in the scene file format 902 when that file is loaded. The bounding boxes are then preferably stored in a database for reference during the on/off function described below.

The consumer software 108 preferably has an on-screen control for turning the 3D guides on and off (the on/off function). When 3D guides are turned on, all axis-aligned bounding boxes in the list are retrieved and displayed to the consumer. When 3D guides are turned off, the axis-aligned bounding boxes remain in the list, but are not displayed.

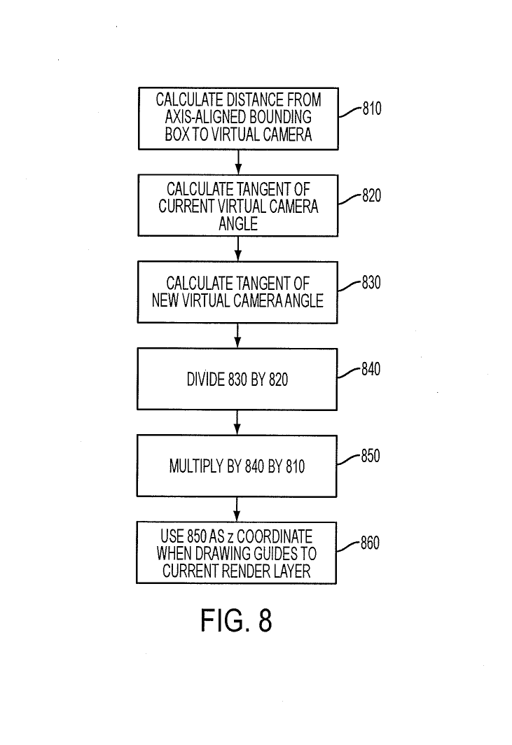

The consumer software 108 is also preferably configured to adjust the 3D guides to reflect changes in the virtual camera angle of view. Whenever the consumer changes the virtual camera's angle of view there is a corresponding movement of the virtual camera in the z-direction—i.e., into or out of the viewing screen. FIG. 8 is a flow chart showing how the consumer software 108 adjusts the 3D guides to reflect changes in the virtual camera angle of view. The consumer software 108 first calculates the distance of the virtual camera to the axis-aligned bounding box for the current virtual camera angle in step 810. Then, the consumer software 108 calculates the tangent of the current virtual camera angle in step 820. After the consumer has changed the virtual camera angle, the consumer software 108 calculates the tangent of the new virtual camera angle in step 830. Next, in step 840, the consumer software divides the value calculated in step 830 by the value calculated in step 820 to arrive at a distance ratio. The distance ratio calculated in step 840 is then multiplied by the distance value calculated in step 810 (step 850). Finally, in step 860, the value calculated in step 850 is used as the z-coordinate in the virtual camera matrix when drawing the 3D guides to the current render layer.

With the above, consumers can realistically add CG 3D visual effects to digital videos without the need for complex and costly design and animation software.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that the present invention be limited only by the claims and the equivalents thereof.

What is claimed is:

1. A method for distributing computer generated 3D visual effects over a communications network, the method comprising:
receiving a computer generated 3D visual effect in a scene file format; and
providing a user interface that permits simultaneous rendering and compositing of the computer generated 3D visual effect on a frame-by-frame basis with a digital video, wherein the user interface is configured to allow adjusting of a control that alters rendering of the computer generated 3D visual effect in the scene file format.

2. The method of claim 1, wherein the user interface is configured to calculate a movement of an element of the digital video and adjust a perspective of the computer generated 3D visual effect during the simultaneous rendering and compositing of the computer generated 3D visual effect on the frame-by-frame basis with the digital video so as to substantially match the movement of the element of the digital video with the perspective of the computer generated 3D visual effect.

3. The method of claim 2, wherein the movement of the element of the digital video is at least one of a camera yaw, a camera pitch, or a camera roll.

4. The method of claim 1, wherein the user interface is configured to identify an element in the digital video to interact with the computer generated 3D visual effect, render the element for interaction with the computer generated 3D visual effect, and alter an appearance of the computer generated 3D visual effect based upon the interaction of the rendered element with the computer generated 3D visual effect during the simultaneous rendering and compositing of the computer generated 3D visual effect on the frame-by-frame basis with the digital video.

5. The method of claim 1, further comprising storing the computer generated 3D visual effect in a database.

6. The method of claim 1, further comprising providing a second interface that converts the computer generated 3D visual effect to the scene file format.

7. The method of claim 1, wherein the computer generated 3D visual effect in the scene file format also includes a custom adjustment for altering a visual appearance of the computer generated 3D visual effect.

8. The method of claim 1, wherein the computer generated 3D visual effect in the scene file format includes data representing a movement of a vertex of the computer generated 3D visual effect as a parametric equation of time.

9. The method of claim 1, further comprising displaying a three dimensional guide representing a size, a position and an orientation of the computer generated 3D visual effect while simultaneously rendering and compositing the computer generated 3D visual effect on the frame-by-frame basis with the digital video.

10. A system for distributing computer generated 3D visual effects over a communications network, the system comprising:
a database that stores a computer generated 3D visual effect in a scene file format; and
a user interface that provides access to the database and is configured to allow the computer generated 3D visual effect in the scene file format to be rendered and composited on a frame-by-frame basis with a digital video,
wherein the user interface permits manipulation of a control that alters rendering of the computer generated 3D visual effect.

11. The system of claim 10, wherein the user interface is configured to calculate a movement of an element of the digital video and adjust a perspective of the computer generated 3D visual effect during the simultaneous rendering and compositing of the computer generated 3D visual effect on the frame-by-frame basis with the digital video so as to substantially match the movement of the element of the digital video with the perspective of the computer generated 3D visual effect.

12. The system of claim 11, wherein the movement of the digital video is at least one of a camera yaw, a camera pitch, or a camera roll.

13. The system of claim 10, wherein the user interface is configured to identify an element in the digital video to interact with the computer generated 3D visual effect, render the element for interaction with the computer generated 3D visual effect, and alter an appearance of the computer generated 3D visual effect based upon the interaction of the rendered element with the computer generated 3D visual effect during the simultaneous rendering and compositing of the computer generated 3D visual effect on the frame-by-frame basis with the digital video.

14. The system of claim 10, further comprising a converting interface configured to convert the computer generated 3D visual effect into the scene file format.

15. The system of claim 10, wherein the computer generated 3D visual effect in the scene file format includes data representing a movement of a vertex of the computer generated 3D visual effect as a parametric equation of time.

16. The system of claim 10, wherein the computer generated 3D visual effect in the computer generated 3D visual effect file format includes a custom adjustment for altering a visual appearance of the computer generated 3D visual effect.

17. The system of claim 10, wherein the user interface is configured to display a three dimensional guide representing a size, a position and an orientation of the computer generated 3D visual effect while simultaneously rendering and compositing the computer generated 3D visual effect on the frame-by-frame basis with the digital video.
